(19) United States
(12) Patent Application Publication
(10) Pub. No.: US 2010/0091309 A1
(43) Pub. Date: Apr. 15, 2010

(54) MULTI-ARRANGE ABLE AND IMAGE FORMING APPARATUS

(75) Inventor: Hisaya ISHIO, Saitama (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/576,143

(22) Filed: Oct. 8, 2009

Related U.S. Application Data
(60) Provisional application No. 61/104,198, filed on Oct. 9, 2008.
(60) Provisional application No. 61/104,204, filed on Oct. 9, 2008.

(51) Int. Cl. H04N 1/60; G06F 15/00

(52) U.S. Cl. 358/1.9; 358/1.13

(57) ABSTRACT

According to an embodiment of the present invention, an image forming apparatus includes an image forming section to fix a developer image to a sheet material and to output it, a control unit that is provided independently of the image forming section and supplies image data and an image output condition to the image forming section, and an operation section that is provided independently of the image forming section and the control unit, and outputs a control signal for supplying the image data and the image output condition to the image forming section.

### CROSS-REFERENCE TO RELATED APPLICATION

This application is based upon and claims the benefit of priority from: U.S. provisional application No. 61/104,198 and No. 61/104,204 both filed Oct. 9, 2008, the entire contents of each of which are incorporated herein by reference.

### TECHNICAL FIELD

The present invention relates to a clustered image forming apparatus in which a space for holding a sheet-like material to which an image or a document is outputted is reduced, and it is possible to prevent the outputted image or document from being carelessly taken out by a third person, and which is multi-arrange able according to a use frequency or maximum processing capacity (required by a user).

### BACKGROUND

An image forming apparatus, such as a color copier and a printer, called an MFP (Multi-Functional peripheral) is well known.

The MFP is usually one apparatus including an image forming apparatus, an image reading apparatus, a control and storage section, an operation section and the like, and when copying is performed, the image forming section of the apparatus forms an image from the read image and outputs it.

In recent years, in order to effectively use the space of an office, in a single multi-functional peripheral, an in-body paper discharge system becomes mainstream, in which a sheet discharge section is provided between the printer and the scanner, and an equipment in which a finishing apparatus is contained in the body becomes widespread.

Besides, plural MFPs are connected to a network, or a certain MFP operates another MFP to give an instruction of an operation or to print the read image data, or a PC (Personal Computer) on the network operates the respectively MFPs remotely, and image reading or formation of an output image can be performed.

However, when an operation property is considered, the position of the scanner and the operation section can not be made high, and within the limitation, the load capacity must be set so that the finishing apparatus is contained in the in-body space or the function must be limited. When a large number of sheets are handled or functions such as book binding and punching are desired, a large finishing section is disposed at the side of a main frame, and an installation space is required by that. Besides, since the miniaturization of a sheet containing section or a printer unit is limited, an operator using a wheelchair is obliged to use the scanner at such a height that the operation is hard.

Japanese Patent No. 3860829 is known in the background as stated above.

However, the above patent has a defect (problem) that when the sheet containing capacity is increased (for example, a paper feed cassette is added or paper discharge load capacity is increased), the position of a scanner and an operation section must be made high, and a bad influence is given to an operation property.

Besides, JP-A-2004-15566 (document 2) is known as disclosing another related art.

However, the document 2 has a defect (problem) that only the process of the amount contained in an equipment body can be performed, and in order to increase the amount of process, the position of a scanner must be made high, or a large finishing apparatus must be installed at the side of an equipment through a relay apparatus.

Besides, JP-A-2001-335222 (document 3) is known as disclosing another related art.

However, the document 3 has a defect (problem) that in order to restrict the height of a finishing apparatus to within the in-body space, a unit is made large in the direction of a paper path, and when an auxiliary tray is extended to load a large size sheet, an equipment installation space becomes large.

Besides, JP-A-2005-99567 (document 4) is known as disclosing another related art.

However, the document 4 has a defect (problem) that although the height of a scanner and an operation section can be adjusted according to the height of an operator, when a printer and a finishing apparatus having a volume exceeding an appropriate operation height or functions are provided at a lower part of the scanner, handling can not be performed.

Besides, JP-A-62-201775 (document 5) is known as disclosing another related art.

However, there is a defect (problem) that in recent years, since a mechanism becomes complicated due to the increase of functions (offset catch, punch, staple, saddle stitch functions, etc.) of a finishing apparatus, even if a unit is simply made rotatable, handling can not be performed in the maintenance. Since the miniaturization of a sheet containing section or a printer unit is limited, an operator using a wheelchair is especially obliged to use the scanner at such a height that the operation is hard.

Further, JP-A-2000-174964 (document 6) is known as disclosing the related art as stated above.

However, this has a defect (problem) that is premised that apparatuses which are means for operating an image processing apparatus such as a copier or a facsimile, and each including a control section of image data, a storage section and the like are connected to each other, and there are defects that it is burdensome for a user to purchase the plural apparatuses and to configure an environment, and even if there is a need to use a printer having no image reading unit, the handling can not be performed by the technique.

In view of the above circumstances, a development team including the inventor of this application filed U.S. application Ser. No. 11/406,161 (filed Apr. 18, 2006), and still continues the development.

### SUMMARY

An object of the invention is to provide a mechanism in which an image reading control apparatus including an operation section, a storage and control section and a scanner section is separate from an image forming apparatus (hereinafter referred to as a printer), and the respective ones are network connected, so that they function as one multi-functional peripheral.

Another object of the invention is to provide a multi-functional peripheral in which the height of a scanner and an operation section can be set to such a height that importance is given to an operation property.

According to an aspect of the present invention, there is provided an image forming apparatus comprising: an image forming section to fix a developer image to a sheet material and to output it; a control unit that is provided independently of the image forming section, and supplies image data and an image output condition to the image forming section; and an operation section that is provided independently of the image forming section and the control unit, and outputs a control signal includes at least one of the image data and the image output condition to the image forming section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows an example of a multi-functional peripheral (MFP) to which an embodiment of the invention is applied;

FIG. 2 shows an example of arrangement of an image output section for image output using the MFP shown in FIG. 1;

FIG. 3 shows an example of arrangement of respective components of the image output section for the image output using the MFP shown in FIG. 1;

FIGS. 4A to 4C show variations of an image output section which are applied to the arrangement of the image output section shown in FIGS. 2 and 3;

FIGS. 5A to 5C respectively show states in which a security cover is attached to the image output section shown in FIGS. 4A to 4C;

FIG. 6 shows an example of an input of a release key for opening the security cover shown in FIGS. 5A to 5C and a display for guiding the input of the release key;

FIG. 7 shows an example of a state where the security cover shown in FIGS. 5A to 5C is opened;

FIGS. 8A and 8B show an example of an image reading section included in the MFP shown in FIG. 1; and

FIGS. 9A and 9B show an example of an operation when an image is read by using the image reading section shown in FIGS. 8A and 8B.

### DETAILED DESCRIPTION

Hereinafter, an embodiment of the present invention is explained in detail below with reference to the accompanying drawings.

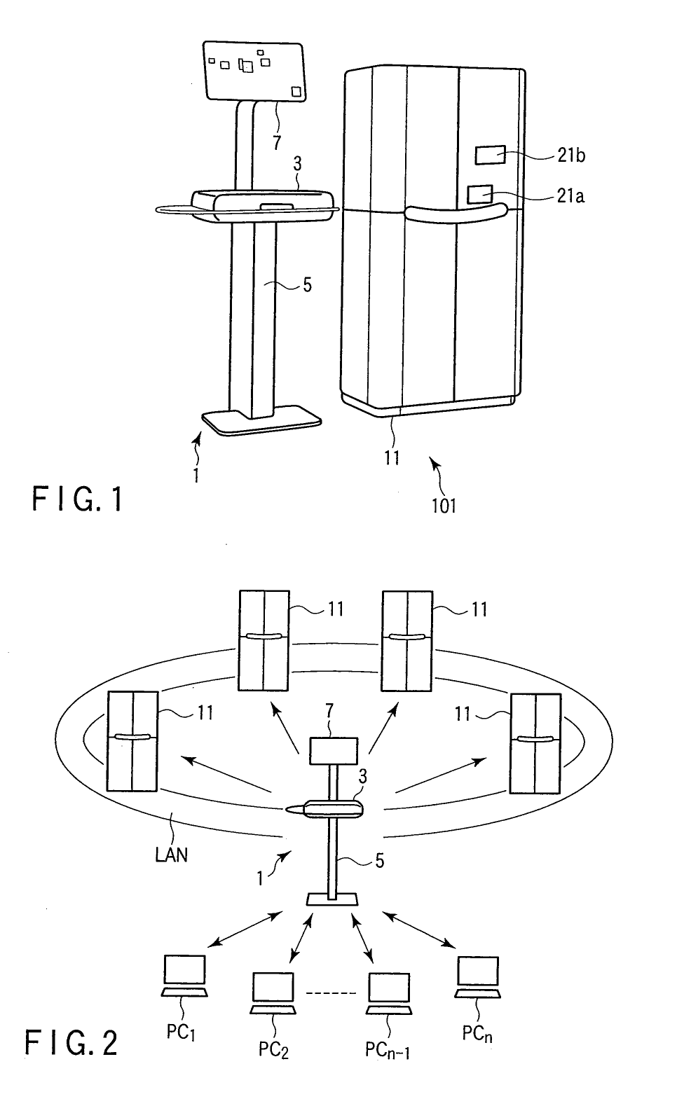

FIG. 1 shows the outline of a multi-functional peripheral (MFP) to which the invention can be applied.

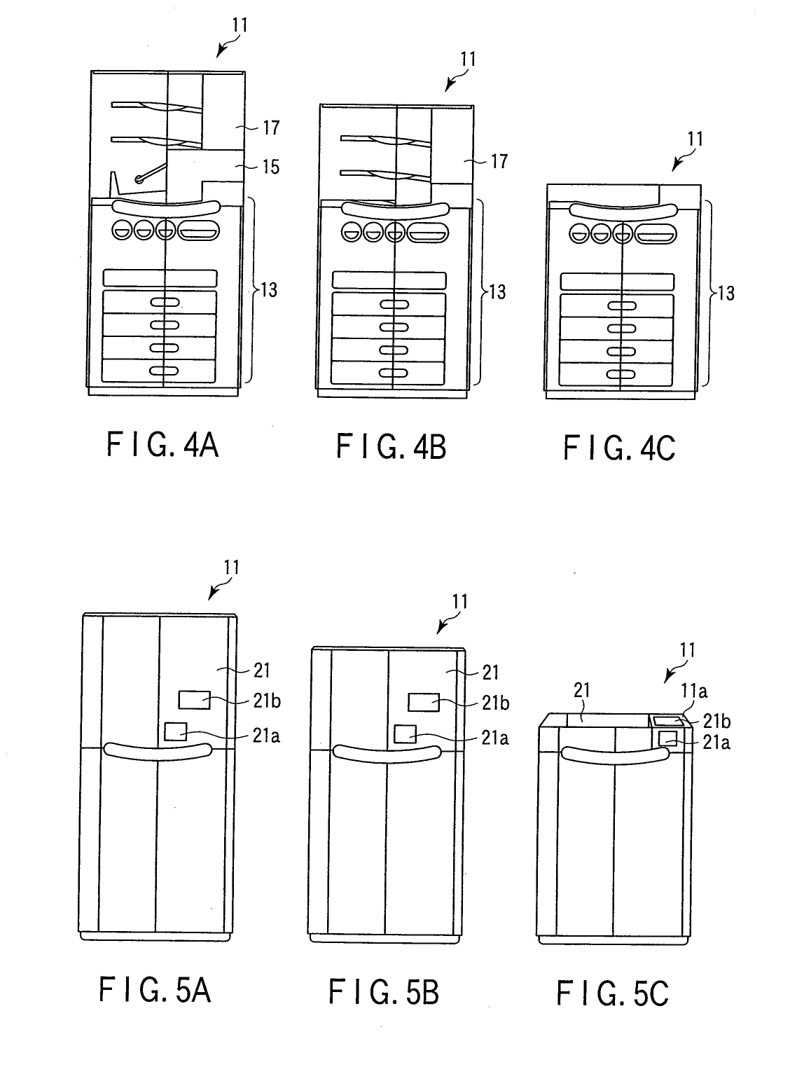

An MFP 101 is for forming “output image” of a state where it is held by a sheet material generally called a sheet, and includes a control input section 1 including at least an image reading section 3, a control unit 5 and an operation panel (also called an operation section or a control panel) 7, and an image output section 11 including an image forming section 13. The image output section 11 can independently operate as a printer apparatus, and the number thereof may be different from that of the control input sections 1. Although described later by use of FIG. 4A and FIG. 5A, or FIG. 4B and FIG. 5B, or FIG. 4C and FIG. 5C, the image output section 11 includes at least the image forming section 13, and in accordance with a request of a user, a saddle stitch unit 15, a finisher 17 and an eraser 19 are combined. FIG. 4C and FIG. 5C show an example of a printer-only type in which the saddle stitch unit 15 and the finisher 17 are omitted. Although not described in detail, the saddle stitch unit 15 includes a stapler (which may be a saddle stitch mechanism to staple the center of sheets for simple book binding called saddle stitch) to staple an arbitrary number of sheet materials as output images. When designation is previously made by the operation panel 7 or an external PC, the saddle stitch unit staples (saddle stitches) an arbitrary number of sheet materials as output images. In accordance with a request of a user, the finisher 17 operates in a group mode to hold each page when a plurality of same pages are outputted, or in a sort mode to hold the output of an arbitrary number of sheets (copies) in (copy) units, and holds the image output. Although not described in detail, the saddle stitch unit 15 and the finisher 17 include a punch unit to punch an arbitrary number of holes at specified positions, which are usable for filing of sheet materials as output images, in accordance with the input of a control command from the operation panel 7 or the PC.

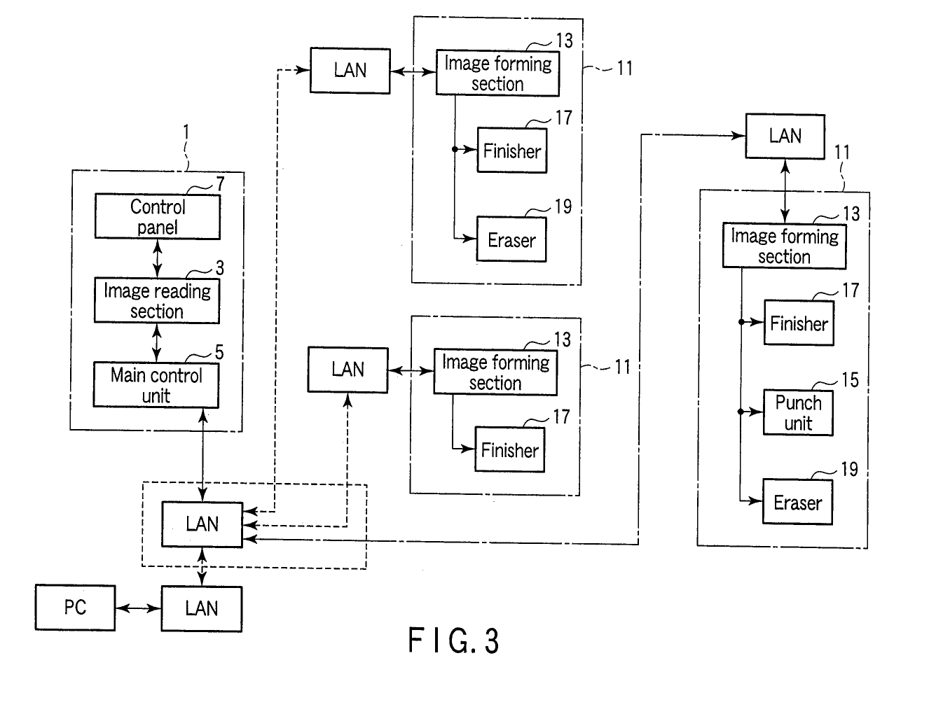

FIG. 2 and FIG. 3 show an example of external input apparatuses to supply image data to the image output section 11. For example, a PC (Personal Computer) is connected to the control unit 5 of the control input section 1. The control unit 5 (which may be integral with the image reading section 3) and the image output section 11 are mutually connected through an arbitrary signal transmission system such as a wire harness prepared for the respective bottoms, LAN (Local Area Network), or power line LAN (power line in a building is used as wiring for LAN, a power source consent used for power supply to an apparatus is also used, and a control signal and data can be transmitted). The control unit 5 may include a server, or may be connected through an independent external server as indicated by a dotted line in FIG. 3. A wireless signal transmission system can also be used. The signal transmission system can be directly connected by the wire harness.

The image reading section 3 includes an image sensor to capture (hereinafter referred to as “read”) information held by a read object (document) and to output it as image data. The image reading section 3 integrally includes an auto document feeder in which when the object is sheet-like, after reading of the information is ended, the sheet (object) for which the reading is moved from the read position, and a next document is guided to the read position. The auto document feeder includes a sheet inverting mechanism to invert the front and back of the sheet-like object.

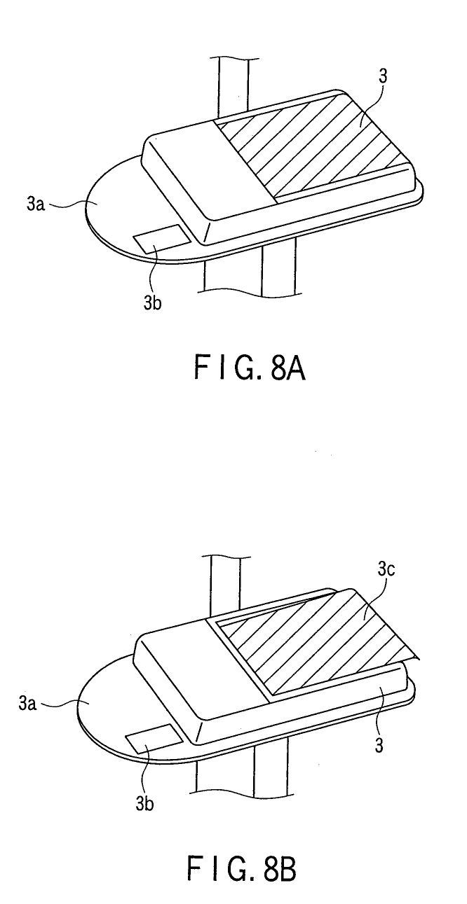

Although described later with reference to FIG. 8A and FIG. 8B, the image reading section 3 includes a document placing stand (table section) 3a extending in a lateral direction at the same height as a platen glass (image reading surface) 3d. A display section 3b serving also as a personal authentication reader is prepared in the table section 3a. The table section 3a may be provided with a portion on which a small product such as a clip is placed.

Besides, although described later with reference to FIG. 7A and FIG. 7B, and FIG. 8A and FIG. 8B, the image reading section 3 has such a structure that in order to prevent dust from entering the auto document feeder, a top cover 3c is made movable and covers a document insertion port at the time of non-reading.

Although not described in detail, the control unit 5 includes a power source section to convert electric power from a commercial power source into voltage and current suitable for the operation of each part of the apparatus, an image processing section to supply image data supplied from the image reading section 3 to the image output section 11, and a main control block to control the respective operations of the image reading section 3 and the image output section 11 in accordance with the control command supplied from the operation panel 7. The main control block includes a function as a server, and when the number of the image output sections 11 is two or more, the main control block it is possible to instruct the image output section 11 to perform image formation corresponding to image data transferred from an arbitrary apparatus different from the image reading section 3. Besides, the main control block monitors the abnormality of the operation panel 7, the image reading section 3 or the image output section 11, the remainder of the sheet material held by the image output section 11 and the remaining amount of developer (toner), and staples (needles) when the finisher including the stapler is connected to the image output section 11.

Besides, the control unit 5 has a function that when a PC on a network instructs the control unit 5 to output an image, and when an image output section is specified, the image is generally outputted from the specified image output section, however, when an image output section is not specified, for example, when a large amount of color image output is instructed, an image output section suitable for the instruction is automatically selected and an output is made. By this, a waiting time until all print jobs are ended is reduced. In contrast, the mono-chromatic image is delivered arbitrary image output section 11 for forming the mono-chromatic image only and for forming the color image.

In the latter case, the control unit guides the PC as to which image output section outputs an image, and the display section provided on the security cover displays which PC gives the instruction, and the user authentication is required. Thus, forgetting to take out the output paper and the leak of secret information can be prevented.

The operation panel 7 is positioned above the image reading section 3. The operation panel 7 is supported by a swingable or rotatable arm or the like, and an interval between itself and the image reading section 3 or the relative position to the image reading section 3 in the plane direction can be changed. The operation panel 7, the image reading section 3 and the control unit 5 have such total height and size that the image reading surface of the image reading section 3 described later with reference to FIG. 8A and FIG. 8B has a height comparable to the height of user's waist (adult). The control unit 5 is formed in, for example, a columnar support section (base) to support the image reading section 3. The control unit 5 may be prepared integrally with the image reading section 3 (in this case, the support section shares the role as the leg of a simple console).

The operation panel 7 includes a display section to provide, for example, a GUI (Graphical User Interface), an input section (Touch Panel) to receive a control input to the display (GUI) on the display section, and a control circuit which interprets the control input received by the input section, outputs a control command corresponding to the result, and executes the operation of the display section and the input section. Besides, the operation panel 7 can input a release key for personal authentication or can communicate for personal authentication.

Since the operation panel 7 and the image reading section 3 are separated from the image forming section 13 (the image output section 11), the height of the image reading section 3 and the operation panel 7 can be set to such a height that importance is given to an operation property. By this, for example, an operation environment suitable for an operator using a wheelchair can be easily configured.

The operation panel 7 has a knob 7a for enabling the change of the interval between itself and the image reading section 3 and the relative position to the image reading section 3 in the plane direction, and the knob 7a has a built-in microphone 7b for voice input. By this, when a voice recognition program is stored in the control unit 5, a voice instruction input can be performed for a previously determined work.

By the structure of the operation panel 7 in which a large display is positioned above the control unit 5, a visual recognition property can be improved when information as to the status of the equipment or as to which user makes an output is displayed.

Although a detailed description is omitted, the image forming section 13 of the image output section 11 includes photoconductive bodies to hold latent images corresponding to four image data of C (Cyan), M (Magenta), Y (Yellow) and BK (Black) based on a well-known subtractive process, developing mechanisms (for four colors) to develop the latent images held by the respective photoconductive bodies by supplying a visualizing agent such as toner and to form visualized images, a transferring mechanism (transfer mechanism) to transfer the visualized images formed by the developing mechanism onto a sheet material, a fixing mechanism (fixation mechanism) to fix the visualized images to the sheet material, a sheet material holding mechanism to contain a sheet material, and a material moving mechanism to guide the sheet material held by the sheet material holding mechanism from the sheet material holding mechanism through the transferring mechanism (transfer mechanism) to an output image holding section. The material moving mechanism includes a material inverting mechanism to invert the front and back of the sheet material.

Although not shown in detail, the sheet material holding mechanism includes, for example, at least one tray or cassette-like stock section. Each stock section contains a sheet material to hold a visible image formed by the image output section 11, and provides the material of largeness (size) defined based on the size of image data or the request of a user to the image output section 11 (transfer mechanism) based on the request of the image output section 11 side. In order to supply the sheet material for transfer of a toner image to the transfer mechanism at specified timing, the sheet material holding mechanism includes a pick-up roller to pick up a sheet material from the stock section containing the sheet material of the corresponding size according to the image forming operation not described in detail, and a separation roller to prevent two or more sheet materials from being taken out by the pick-up roller.

The sheet material moved to the transfer mechanism of the image output section 11 receives the visible image formed by the developing mechanism in the transfer mechanism, and is moved to the fixing mechanism. The sheet material moved to the fixing mechanism is fixed with the toner image. The sheet material to which the toner image is fixed in the transfer mechanism is moved as the “output image” to the finisher 17. The sheet material moved to the finisher 17 is punched (bored)/stapled according to an instruction (user's request) from the operation panel 7 (control input section 1) or an external PC.

Although not described in detail, the finisher 17 and the saddle stitch unit 15 are formed to be connectable to a path branching from a normal paper discharge path at an upper part of the fixing mechanism. A normally blocking cover (denoted by 11a in FIG. 5C) is removed, and the finisher 17 and saddle stitch unit 15 are connected.

The finisher 17 and the saddle stitch unit 15 have, as the specifications required by the user, a structure in which arbitrary units are stacked, and in order to keep the accuracy, it is desirable that the paper path at the paper discharge side is fixed, and a mechanism section including an opposite path is separated in view of a jam process. Even when the structure is such that the right side cover is opened at the time of a jam process, since the structure to protrude a manual tray is generally included, an installation space is not further required. Besides, although the details are omitted, a mail bin specification finisher may be combined.

In the image forming section having the structure as stated above, even when the finisher or the saddle stitch unit is added, the installation space is not changed, and further, there is no obstruction to prevent sheet pick-up at an upper part of the storage tray, and a high operation property can be obtained. Besides, since the image reading section 3 and the operation panel 7 are separated from the image output section 11 (image forming section 13), the degree of freedom of the image reading section 3 and the operation panel 7 become high, and the equipment excellent in operation property for the operator can be provided.

Incidentally, in the related art, in the office where plural MFPs are introduced, it is necessary for an operator to go to each equipment and to perform an operation according to a function. However, in this proposal, an operator has only to go to one image reading control apparatus and to perform an operation, and the usability is excellent.

Besides, in the related art, in an operation from the PC side, for example, when data stored in an MFP is outputted or downloaded, it is necessary to find data from the plural MFPs and to access it. However, in this proposal, it is sufficient if an access is made to one image reading control apparatus, and the usability is excellent.

Besides, in the related art, the installation space of the finisher 17 and the saddle stitch unit 15 is usually arranged at the side of the MFP, and when plural MFPs are installed, a wide space is required. However, in this proposal, since the installation space is not increased, the space can be saved. That is, in general, the image output section has a structure that while a part of a paper conveyance path is in the right and left direction, the paper feed cassette is drawn out in the direction (front) orthogonal to the path, and the storage tray on which the output paper is loaded facedown so that the surface of the toner image is directed downward is provided at an upper part of the image forming section. Thus, it is also possible to prevent the discharged output image (sheet material) from protruding from the main frame.

In the image forming apparatus 101 described above, the operator can use the GUI and operation procedure (operation flow) displayed on the operation panel 7 formed integrally with the control unit 5 by an operation common to all the image output sections 11. The contents of the GUI and the flow are automatically switched according to the specification of the operated image output section 11 in accordance with the library held by the control unit 5 or a server positioned on the LAN or a host computer. Thus, unlike the related art, the confusion is not caused by operation systems different between equipments, and comfortable use can be achieved.

The operation of the operation panel 7 is enabled by authentication from an authentication unit (display section 3b described later with reference to FIG. 8A and FIG. 8B). By this, switching to a GUI uniquely edited for a previously set user simultaneously with the identification of the user is automatically performed.

Since the operation panel 7 is made large, various operations such as settings and registration, data transmission (including the PC and server on the network), use of the Internet and the like can be easily performed.

With respect to the change and correction of the GUIs and programs, the main control unit 5 has only to be updated, and it can be collectively performed.

The image forming sections shown in FIG. 4A, FIG. 4B and FIG. 4C will be described with reference to FIG. 5A, FIG. 5B and FIG. 5C, and each of them has a security cover. The security cover 21 is useful for preventing a third person from reading and carrying out an image or a document held by a sheet material stored in the portion where the outputted sheet material and the printed sheet material for recycle are stored.

The security cover 21 is normally in a lock state, and includes a release input section 21a to receive an input of a release key (authentication character string/numeral string) for allowing (for personal authentication) the user who instructs image formation (output of an output image) to open the security cover 21, or communication through an identification medium (ID card) for personal authentication. It is desirable that the release input section 21a is of, for example, a touch panel type in which the release key can be inputted, and integrally includes a wireless transmission and reception section capable of communicating with the identification medium, such as the ID card, for authentication. Accordingly, only when it can be identified that the user is the user who instructs the image formation (output of the output image) by the input of the release key or by the user who instructs the image formation (output of the output image) by the communication through the ID card, the security cover 21 is opened.

A display section 21b which guides the user to open the security cover 21 by the input of the release key or the communication through the ID card is positioned on the security cover 21. In general, the display section 21b displays a procedure for opening the security cover 21, such as “Please input the release key” or “Please touch the ID card”. As the release key, for example, “fingerprint” can also be used. The security cover 21 is preferably divided for each storage tray of the finisher 17 and is formed to be openable. For example, when two or more users simultaneously or almost simultaneously give instructions of image formation (output of the output image), a message such as “The output for Mr. A is the uppermost tray” can also be outputted on the display section 21b.

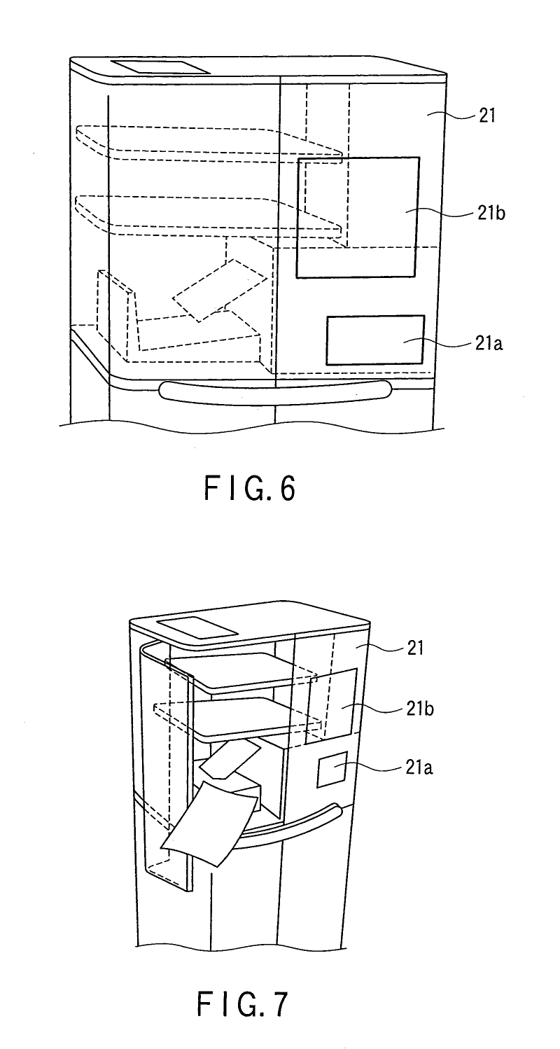

FIG. 6 and FIG. 7 show the enlarged security cover having the release input section and the display section.

The security cover 21 is subjected to a smoke (sand blast) process to such a degree that it can be visually recognized that an image output exists in the inside, and accurate recognition of a character string or a figure included in the image output is not allowed. The security cover informs the existence of the image output to the user who gives the instruction of the image output.

When the user inputs the release key from the release input section 21a, or the ID card holding the release key touches the release input section 21a, and when the authentication is obtained, as shown in FIG. 6, the security cover 21 is opened. In the example of FIG. 6, all storage trays are covered with one cover. However, as described above, when the cover is divided for each storage tray of the finisher 17 and is formed to be openable, the security is improved.

FIG. 8A and FIG. 8B show features of the image reading section.

As is apparent from FIG. 8A and FIG. 8B, the image reading section 3 formed integrally with the control unit 5 includes the table area 3a in a state where the surface including the image reading surface (described later with reference to FIG. 8A and FIG. 8B) is developed (expanded).

The table area 3a includes the display section 3b to display the release key for allowing the user to open the security cover of the image output section 11 when the operation (work) used by the user is, for example, “image reading” and the read image is printed out (image formation) by the image output section 11. The display section 3b is formed integrally with the communication section for transferring the release key to the identification medium for personal authentication, such as an ID card, held by the user. By this, the release key can be transferred so that the user can easily carry it by the ID card or the like.

The display section 3b includes a wireless reader/writer (not shown), and reading the ID code or ID number for personal authentication with the ID card (identification medium) for personal authentication. The display section 3b outputs release key for allowing (for personal authentication) the user who instructs image formation (output of an output image) to open the security cover 21 through the main control unit 5 and the network (the LAN). The display section 3b writing the release key to the ID card (identification medium) for personal authentication, also. Therefore, the user who instructs image formation (output of an output image) to open the security cover 21, contacts the ID card to the display section 21b of the security cover 21.

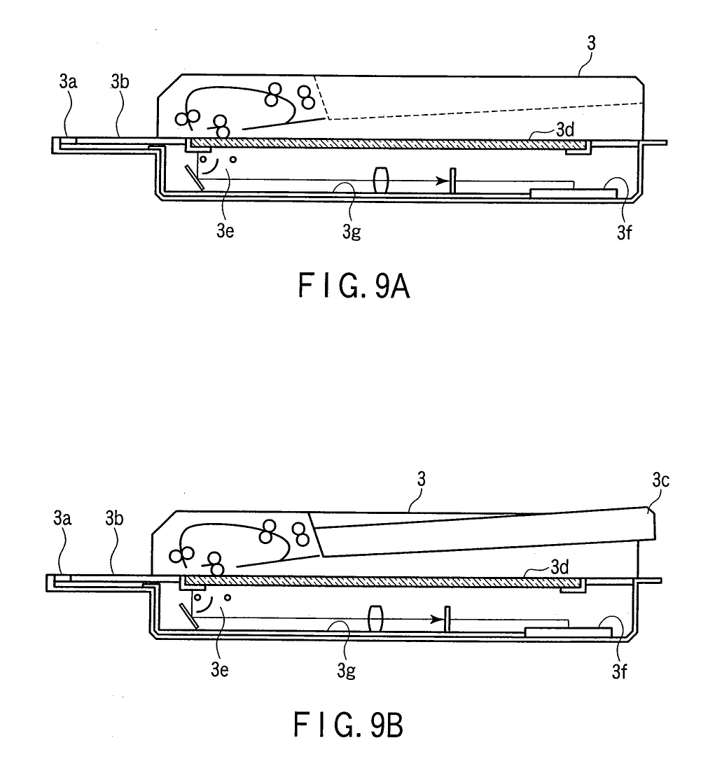

As shown in FIG. 9A and FIG. 9B, the top cover 3c is slid and the image reading section 3 functions as a document tray for guiding a sheet-like read object, that is, an original document to the inside of the image reading section 3. At the normal time, the movable section to guide the sheet-like original document to the inside of the image reading section 3 is covered with the top cover. By this, it is prevented that a foreign matter enters the movable section or a user's finger or the like erroneously touches the movable section. Naturally, it is also reduced that a necktie or the like is entangled.

The display section 3b can input a control command for sliding the top cover 3c from the non-operation time shown in FIG. 9A to the reading time shown in FIG. 9B in order to set the sheet-like read object, and includes, for example, a “start” or “read” button prepared in the display section 3b. When reading is ended, after the object original document is drawn out, when a specified time passes, the top cover 3c is returned to the initial position (closed position).

The image reading surface 3d is useful for converting image information held by a non-sheet-like read object, such as a book or a cubic material, into image data.

The image information of the read object positioned on the image reading surface 3d is inputted as the variations of light and shade to a CCD sensor or an image detector by a reading system 3e, is converted into image data and is guided to a signal processing section 3f. The image data guided to the signal processing section 3f is supplied to the control unit 5, is subjected to a specified image process, and is supplied to a not-shown storage device or the image output section 11. An input signal from the display section 3b is also supplied to the control unit 5 through the signal processing section 3f.

As stated above, since the operation section and the image reading section are separated from the image forming section, the height of the image reading section and the operation section can be set to such a height that importance is given to the operation property, and especially, an operation environment suitable for an operator using a wheelchair can also be easily formed.

The operation section can be disposed above (outside the movable range of the platen cover or the auto document feeder) the image reading section, and there is no obstruction at the right and left and upper parts of the operation section. Thus, the touch panel can be made large, and the operation property can be improved.

Since there is no obstruction to block an upper part of the image forming section (image output section), the height of the finishing section can be set freely as long as it does not exceed the range of the operation (sheet pick-up, jam process, etc.) of the operator, the number of stack sheets can be increased and the function of the finishing process can be raised.

Further, when the instruction of image output is given from the PC on the network to the control unit, and when the image output section is specified, the specified image output section generally outputs the image output. However, when the image output section is not specified, for example, when an instruction of a large amount of color image output is given, by the function to automatically select the image output section suitable for the instruction and to make an output, a waiting time until all print jobs are ended is reduced.

In the latter case, the control unit guides the PC as to which image output section outputs the image output, the display section provided on the security cover displays which PC gives the instruction, and the user authentication is requested. Accordingly, forgetting to take out the output paper and the leak of secret information can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an image forming section to fix a developer image to a sheet material and to output it;
a control unit that is provided independently of the image forming section, and supplies image data and an image output condition to the image forming section; and
an operation section that is provided independently of the image forming section and the control unit, and outputs a control signal includes at least one of the image data and the image output condition to the image forming section.

2. The apparatus of claim 1, wherein the control section is operated a saver member.

3. The apparatus of claim 2, wherein the control section is formed with the operation section.

4. The apparatus of claim 1, further comprising:
an image inputting section that generates image data to form the developer image by the image forming section.

5. The apparatus of claim 4, wherein the control section is formed with the operation section and the image inputting section.

6. The apparatus of claim 1, wherein the control section to connects at least two of the image forming section.

7. The apparatus of claim 1, further comprising:
a finisher, is located upside of the image forming section, that holds the sheet material has been fixed the developer image and outputted from the image forming section.

8. The apparatus of claim 1, further comprising:
a saddle stitch unit, is located upside of the image forming section, that stitches the sheet material has been fixed the developer image and outputted from the image forming section.

9. The apparatus of claim 1, further comprising:
a saddle stitch unit, located upside of the image forming section, that stitches the sheet material has been fixed the developer image and a finisher, located upside of the saddle stitch unit, that hold the sheet material has been stitched by the saddle stitch unit or pass-through the saddle stitch unit outputted from the saddle stitch unit.

10. The apparatus of claim 1, wherein the operation section is located upper side of the control section, relatively.

11. An image forming apparatus comprising:
means for outputting a sheet material held with a developer image;
means, provided independently of an image forming means, for supplying image data and an image output condition to the image forming means; and
means, provided independently of the image forming section and the supplying means, for outputting a control signal includes at least one of the image data and the image output condition to the image forming means.

12. The apparatus of claim 11, wherein the supplying means operates a saver member.

13. The apparatus of claim 12, wherein the supplying means formed with the outputting means.

14. The apparatus of claim 11, further comprising:
means for generating image data to form the developer image by the image forming means.

15. The apparatus of claim 14, wherein the supplying means formed with the outputting means and the generating means.

16. The apparatus of claim 11, wherein the supplying means to connects at least two of the image forming means.

17. An image forming method, comprising:
determining whether or the image data is mono-chromatic or the image data including color image; and
instructing the image forming to an image forming section with respect to the determining.

18. The method of claim 17, wherein instructing the image forming to an image forming section for possible to form a color image.

19. The method of claim 17, wherein instructing the image forming to an image forming section for mono-chromatic only.

20. The method of claim 17, wherein instructing the image forming to an image forming section with respect to the color of the image data.
